(19) United States
(12) Patent Application Publication
(10) Pub. No.: US 2025/0220710 A1
(43) Pub. Date: Jul. 3, 2025

(54) Improving Relay Operation In Wireless Networks

(71) Applicant: Cisco Technology, Inc., San Jose, CA (US)

(72) Inventors: Brian D. Hart, Sunnyvale, CA (US); Malcolm M. Smith, Richardson, TX (US); Matthew A. Silverman, Shaker Heights, OH (US)

(21) Appl. No.: 18/751,266

(22) Filed: Jun. 23, 2024

Related U.S. Application Data
(60) Provisional application No. 63/616,563, filed on Dec. 30, 2023.

(51) Int. Cl. H04W 74/0816; H04W 84/12

(52) U.S. Cl. CPC H04W 74/0816; H04W 84/12

(57) ABSTRACT

Improving relay operation in wireless networks may be provided. Improving relay operation in wireless networks can include performing a relay Transmit Opportunity (TXOP) frame exchange with a Relay Station (rSTA), wherein the TXOP frame exchange comprises setting a Modulation and Coding Scheme (MCS) for a second hop frame the rSTA will transmit to a Destination STA (dSTA). A first hop frame can be transmitted to the rSTA for the rSTA to transmit to the dSTA via the second hop frame. Then, an end-to-end Acknowledge (ACK) signal can be received from the rSTA. Relay operation can be improved by implementing an end-to-end ACK, the tSTA determining the TXOP duration, enabling the rSTA to relay Timing Synchronization Function (TSF) timing information to the dSTA, and/or enabling the rSTA to receive a transmission from the tSTA and relay the transmission to the dSTA simultaneously.

### RELATED APPLICATION

Under provisions of 35 U.S.C. § 119 (e), Applicant claims the benefit of and priority to U.S. Provisional Application No. 63/616,563, filed Dec. 30, 2023, the disclosure of which is incorporated herein by reference in its entirety.

### TECHNICAL FIELD

The present disclosure relates generally to improving relay operation in wireless networks.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for improving relay operation in wireless networks;

FIG. 2 is a block diagram of a first signal process for improving relay operation in wireless networks;

FIG. 3 is a block diagram of a second signal process for sharing timing information in a relay;

FIG. 4 is a block diagram of a third signal process for receiving and relaying a transmission;

FIG. 5 is a flow chart of a method for improving relay operation in wireless networks; and

FIG. 6 is a block diagram of a computing device.

### DETAILED DESCRIPTION

### Overview

Improving relay operation in wireless networks may be provided. Improving relay operation in wireless networks can include performing a relay Transmit Opportunity (TXOP) frame exchange with a Relay Station (rSTA), wherein the TXOP frame exchange comprises setting a Modulation and Coding Scheme (MCS) for a second hop frame the rSTA will transmit to a Destination STA (dSTA). A first hop frame can be transmitted to the rSTA for the rSTA to transmit to the dSTA via the second hop frame. An end-to-end Acknowledge (ACK) signal can be received from the rSTA.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In networking, a Station (STA), such as an Access Point (AP), may have weak zones or dead zones in its coverage area. The STA may use a relay to enable a sufficient connection in weak zones, dead zones, and/or areas beyond the STA's typical coverage area. To relay the transmission, the Transmitter STA (tSTA) may transmit to a Relay STA (rSTA), and the rSTA may relay the transmission to a Destination STA (dSTA). The rSTA may be positioned to provide a coverage area that extends beyond the tSTA's coverage area, such as where the dSTA is positioned, or otherwise have improved connections to the tSTA and the dSTA. For example, the Modulation and Coding Scheme (MCS) of the connection between the tSTA and the dSTA may be lower than the MCS between the rSTA and both the tSTA and the dSTA. The same techniques for transmitting from a tSTA to an rSTA may be applied in reverse, for transmitting from the rSTA to the dSTA. Without loss of generality, in the following we consider the path from tSTA to rSTA to dSTA.

The tSTA's transmission to the rSTA may be a first hop frame, and the rSTA's transmission to the dSTA may be a second hop frame. The first hop frame and the second hop frame may occur during a single Transmit Opportunity (TXOP). The tSTA may determine the duration of a TXOP for a relaying a transmission to the dSTA. However, the tSTA may need to know how long the second hop frame will take to complete to determine the duration of the TXOP. A frame can be a Physical Layer Protocol Data Unit (PPDU), an Aggregate-Media Access Control Protocol Data Unit (A-MPDU) of Media Access Control Protocol Data Units (MPDUs) carried as a payload therein, a single MPDU, and the like in example implementations. Methods are described herein for the tSTA to determine and/or or control the duration of the second hop frame to enable the tSTA to set a TXOP duration for a transmission.

In some instances, the dSTA may not be able to detect or receive any transmissions from the tSTA. Thus, the dSTA may not receive a Timing Synchronization Function (TSF) timing information from the tSTA. Methods are described herein for the dSTA to determine the TSF timing information without directly communicating with the tSTA.

In certain embodiments, a rSTA can receive a transmission on one link and forward the transmission on another link before the reception of the transmission is finished. However, the rSTA may ideally only forward portions of the transmission that are intended for the dSTA that do not have errors (e.g., as determined by using an error-detecting code such as a Frame Check Sequence (FCS)). Only forwarding error free or low error portions of the transmission intended for the dSTA can allow the rSTA to reduce power consumption, use less medium time for relaying the transmission to the dSTA 104 (and potentially end the TXOP earlier), and the like.

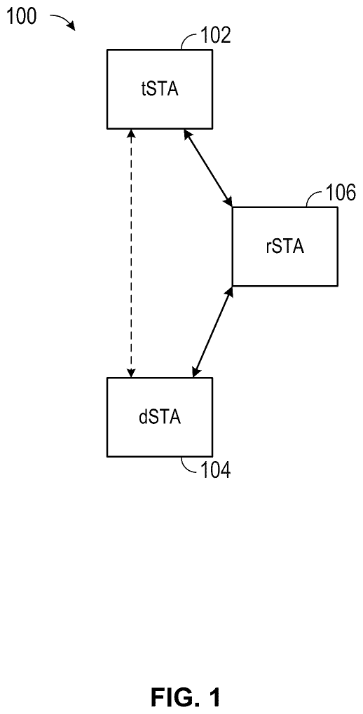

FIG. 1 is a block diagram of an operating environment 100 for improving relay operation in wireless networks. The operating environment 100 may include a tSTA 102, a dSTA 104, and a rSTA 106. The tSTA 102 may be an AP that enables devices, such as the dSTA 104, to connect to a network. The dSTA 104 can be any device that connects to the network to communicate with other devices on the network, such as a smart phone, a tablet, a personal computer, a server, and/or the like. The rSTA 106 may be any device (e.g., an AP, a non-AP STA) operable to relay transmissions between devices, such as the tSTA 102 and the dSTA 104.

To improve the relay of transmissions between the tSTA 102 and the dSTA 104, the tSTA 102 may determine a duration and/or other characteristics of a single TXOP for the duration of the relay process. The other characteristics can include a MCS between the dSTA 104 and the rSTA 106, a Number of Spatial Streams (NSS), a maximum bandwidth, a Downlink (DL) Transmit (TX) time, Uplink (UL) TX time (or equivalently total TXOP duration plus an UL/DL ratio), triggers, and/or the like. Additionally, the rSTA 106 may send a single end-to-end Acknowledge (ACK) rather than a first ACK after receiving a transmission from the tSTA 102 and a second ACK after receiving an ACK from the dSTA 104 acknowledging the reception of the relayed transmission.

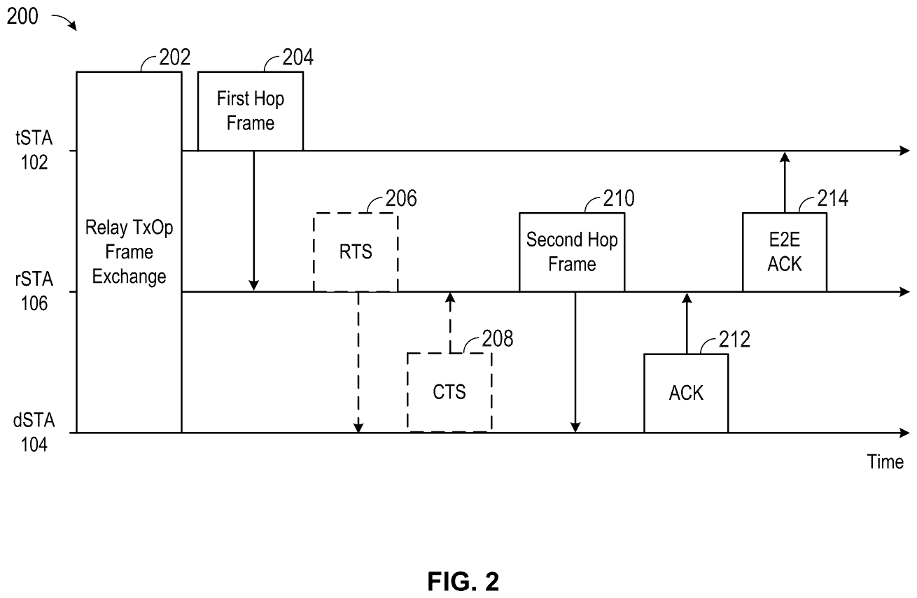

FIG. 2 is a block diagram of a first signal process 200 for improving relay operation in wireless networks. The first signal process 200 may be between the tSTA 102, the dSTA 104, and the rSTA 106, and the first signal process 200 may include a single TXOP for the tSTA 102 to relay a transmission to the dSTA 104 via the rSTA 106.

The tSTA 102 may start the first signal process 200 by initiating a relay TXOP frame exchange 202 with the rSTA 106 or both the rSTA 106 and the dSTA 104. The relay TXOP frame exchange 202 can include communications between the tSTA 102 and the rSTA 106 and/or the dSTA 104 related to a transmission the tSTA 102 determines to send to the dSTA 104 and/or the TXOP during which the tSTA 102 and the rSTA 106 will send the transmission to the dSTA 104. Thus, the relay TXOP frame exchange 202 may include the tSTA 102 sending a Request to Send (RTS) signal to the rSTA 106 or the rSTA 106 and the dSTA 104, the rSTA 106 or the rSTA 106 and the dSTA 104 sending Clear to Send (CTS) signals to the tSTA 102, the tSTA 102 sending TXOP characteristics (e.g., TXOP length, MCS between the rSTA 106 and the dSTA 104, TX time, UL and DL characteristics, triggers, and/or the like) to the rSTA 106 or the rSTA 106 and the dSTA 104, the tSTA 102 sending TSF timing information to the rSTA 106 or the rSTA 106 and the dSTA 104, and/or the like.

To determine and set the duration of the TXOP of the first signal process 200, the tSTA 102 may need to know the characteristics of the connection between the dSTA 104 and the rSTA 106, such as the MCS. The tSTA 102 may set the characteristics of the connection between the dSTA 104 and the rSTA 106, including the MCS, during the relay TXOP frame exchange 202. Therefore, the tSTA 102 can determine the duration of the TXOP based on the characteristics of the connection between the dSTA 104 and the rSTA 106 that the tSTA 102 sets.

After the relay TXOP frame exchange 202, the tSTA 102 can transmit a first hop frame 204 to the rSTA 106. The first hop frame 204 includes the transmission the tSTA 102 determines to send to the dSTA 104. The rSTA 106 may typically send an ACK signal to the tSTA 102 to acknowledge the reception of the first hop frame 204. However, the rSTA 106 may save the information of the typical ACK signal for the end of the first signal process 200.

Once the rSTA 106 receives the first hop frame 204, the rSTA 106 can optionally send a RTS signal 206 to the dSTA 104 to determine if the dSTA 104 can receive a transmission from the rSTA 106. The dSTA 104 may respond to the RTS signal 206 with a CTS signal 208. In other embodiments, the rSTA 106 may assume the dSTA 104 is ready to receive a transmission from the rSTA 106 during the relay TXOP frame exchange 202. For example, the tSTA 102 may first send a CTS-to-self signal (not shown) or may directly transmit the second hop frame 210 without any RTS/CTS exchange.

The rSTA 106 can relay the transmission from the tSTA 102 by sending a second hop frame 210 to the dSTA 104. The second hop frame 210 includes the transmission the tSTA 102 determines to send to the dSTA 104. The tSTA 102 may need to know the duration of the second hop frame 210 to determine the duration of the TXOP. As described above, the tSTA 102 can determine the duration of the second hop frame 210 and therefore the necessary duration of the TXOP by setting the characteristics of the connection between the dSTA 104 and the rSTA 106, including the MCS for example.

After receiving the second hop frame 210, the dSTA 104 can send a dSTA ACK signal 212 to the rSTA 106. The dSTA ACK signal 212 can indicate that the second hop frame 210 was received, including which portions were received correctly and which portions were not received correctly in some examples (i.e., via a BA frame in response to an A-MPDU). The rSTA 106 can then send an end-to-end ACK signal 214 to the tSTA 102 to indicate information associated with the relayed transmission including information associated with the rSTA 106 receiving the first hop frame 204, information associated with the RTS signal 206 and CTS signal 208 or CTS-to-self frame, information associated with the dSTA 104 receiving the second hop frame 210, information associated with the connection between the rSTA 106 and the dSTA 104, and/or the like. For example, the end-to-end ACK signal 214 can include two bits, one bit per hop, to indicate if each hop is successful (e.g., 00 to indicate the A-MPDU of the first hop frame 204 has no good or otherwise valid MPDUs, 10 to indicate the rSTA 106 received the first hop frame 204 but the dSTA 104 did not receive the second hop frame 210, 11 to indicate the rSTA 106 received the first hop frame 204 and the dSTA 104 received the second hop frame 210). In other embodiments, the tSTA 102 can determine the status of the transmission via (i) receiving no ACK signal, including the end-to-end ACK signal 214 if the rSTA 106 does not receive the first hop frame 204, (ii) receiving a Negative ACK (NACK) from the rSTA 106 indicating the dSTA 104 did not receive the second hop frame 210, and (iii) receiving the end-to-end ACK signal 214 indicating the relay was successful.

When the rSTA 106 and the dSTA 104 attempt to or succeed in exchanging the RTS signal 206 and the CTS signal 208, the end-to-end ACK signal 214 can include an indication of whether the RTS and CTS process was successful. The indication may be one or more RTS and CTS process bits. Thus, the tSTA 102 may determine whether the reason the dSTA 104 fails to receive the second hop frame 210 was due to the RTS and CTS process failing. Thus, the tSTA 102 can differentiate between relay failures related to collisions and failures related to Signal to Noise Ratio (SNR).

In some embodiments, the transmission to the dSTA 104, sent via the first hop frame 204 and the second hop frame 210 can be a PPDU containing one or more MPDUs, an A-MPDU containing one or more MPDUs, and the like. The end-to-end ACK signal 214 may further include two bits for each MPDU to indicate whether each MPDU is delivered to the rSTA 106 and whether each MPDU is relayed to the dSTA 104 (e.g., 00 to indicate the MPDU associated with the bits was not delivered to the rSTA 106, 10 to indicate the MPDU associated with the bit was delivered to the rSTA 106 but not the dSTA 104, 11 to indicate the MPDU associated with the bit was delivered to the rSTA 106 and relayed to the dSTA 104).

The end-to-end ACK signal 214 can include information associated with the connection between the rSTA 106 and the dSTA 104. For example, the end-to-end ACK signal 214 can include the Received Signal Strength Indicator (RSSI) associated with the connection between the rSTA 106 and the dSTA 104, the Signal to Interference plus Noise Ratio (SINR) associated with the connection between the rSTA 106 and the dSTA 104, recommended MCS feedback, and/or the like. The tSTA 102 may use the information associated with the connection between the rSTA 106 and the dSTA 104 to help it perform rate adaptation. For example, the tSTA 102 may modify how the tSTA 102 sets the characteristics of the connection between the dSTA 104 and the rSTA 106, including the MCS, for subsequent relays during the relay TXOP frame exchange 202.

In some embodiments, the tSTA 102 can communicate directly with the dSTA 104, for example over a low MCS connection. However, the connection may be sufficient for the tSTA 102 to transmit information associated with a TXOP of the relay and the transmission, such as TSF timing information. In other embodiments, the tSTA 102 and the dSTA 104 may not directly communicate. Thus, the dSTA 104 may need to receive information such as the TSF timing information from the rSTA 106.

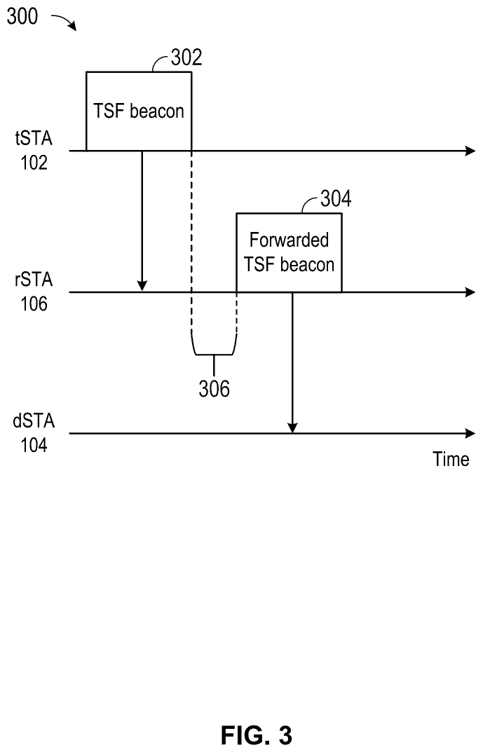

FIG. 3 is a block diagram of a second signal process 300 for sharing timing information in a relay. The second signal process 300 may be a part of the first signal process 200 in some embodiments. For example, the second signal process 300 can occur as part of the relay TXOP frame exchange 202, before the tSTA 102 transmits the first hop frame 204, and/or the like. The second signal process 300 may be implemented when the tSTA 102 and the dSTA 104 cannot directly communicate and the dSTA 104 therefore cannot receive timing information directly from the tSTA 102.

The second signal process 300 can begin with the tSTA 102 sending a TSF beacon 302 to the rSTA 106. The TSF beacon 302 can include TSF timing information the rSTA 106 and the dSTA 104 can adopt. In some embodiments, the TSF beacon 302 may be a beacon or probe response the tSTA 102 transmits to the rSTA 106 in response to a probe the tSTA 102 receives from the rSTA 106.

Once the rSTA 106 receives the TSF beacon 302, the rSTA 106 can generate a forwarded TSF beacon 304 to send to the dSTA 104. Generating the forwarded TSF beacon 304 can include changing the frame subtype of the TSF beacon 302 to an echoed beacon type, overwriting the Transmitter Address (TA) of the TSF beacon 302 with the Media Access Control (MAC) address of the rSTA 106 but leave the Basic Service Set Identifier (BSSID) unchanged, generating an encapsulated relayed management frame containing the information (e.g., the frame) of the TSF beacon 302, or the like. The rSTA 106 may generate the forwarded TSF beacon 304 by modifying or encapsulating the TSF beacon 302 as described to prevent clients from attempting to associate directly to the rSTA 106.

The rSTA 106 may receive the TSF beacon 302 within tens of nanoseconds of the time the tSTA 102 transmits the TSF beacon 302. Additionally, there may be a delay 306 between the tSTA 102 transmitting the TSF beacon 302 and the rSTA 106 transmitting the forwarded TSF beacon 304 to the dSTA 104. The delay 306 may be at least a Short Interframe Space (SIFS), but the delay 306 can include the time the TSF beacon and other beacons are sent, the time groupcast traffic is exchanged, the time for other rSTA 106 transmissions and/or the like. In one embodiment, the rSTA 106 directly modifies the TSF timing information the rSTA 106 includes in the forwarded TSF beacon 304 to account for the delay 306, including delays between the transmission and reception of the TSF beacon 302, any other delays as described above, any encapsulation overheads, and/or the like. Thus, the dSTA 104 will receive TSF timing information the dSTA 104 can use without modification.

In a second embodiment, the rSTA 106 may limit the delay 306 to a SIFS and any operation required for transmitting the forwarded TSF beacon 304 to the dSTA 104. Thus, there may not be any other beacons, groupcast traffic, other rSTA 106 transmissions, and the like during the delay 306 in the second embodiment. The forwarded TSF beacon 304 in the second embodiment may be a retransmission of a close copy of the TSF beacon 302 with one of the above described modifications, including changing the frame subtype, overwriting the TA, encapsulating the TSF beacon 302 in a management frame, or the like. The rSTA 106 may then send the forwarded TSF beacon 304 to the dSTA 104 at the same MCS as the tSTA 102 sent the TSF beacon 302. Thus, the dSTA 104 can determine the MCS of the TSF beacon 302 and modify the TSF timing information for use. The TSF timing information modification can include the dSTA 104 subtracting the rSTA 106 modification time from the time the dSTA 104 received the forwarded TSF beacon 304 plus the duration of the SIFS. The rSTA 106 modification time is the extra time the rSTA 106 took to perform modifications of the TSF beacon 302, including encapsulating the TSF beacon 302 in a management frame for example.

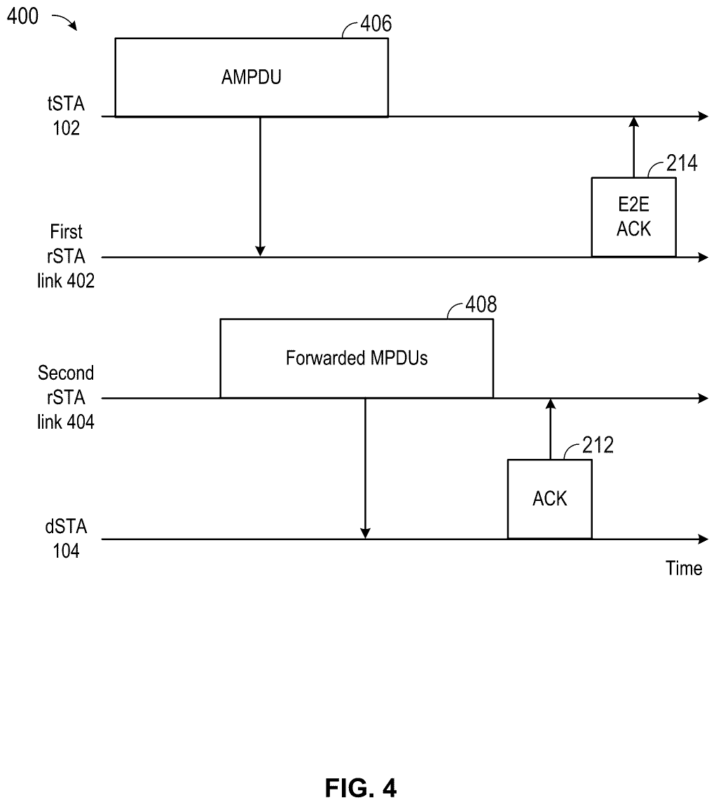

FIG. 4 is a block diagram of a third signal process 400 for receiving and relaying a transmission. The third signal process 400 can include the tSTA 102, the dSTA 104, and the rSTA 106. The rSTA 106 may communicate with the tSTA 102 via a first rSTA link 402 and may communicate with the dSTA 104 via a second rSTA link 404. The third signal process 400 may be utilized if the rSTA 106 is receiving one or more PPDUs in a TXOP on one link (i.e., the first rSTA link 402) with at least one PPDU containing an Aggregated MPDU (AMPDU). Then, the rSTA 106 can forward the verified MPDUs in the one or more PPDUs on another link (i.e., the second rSTA link 404) once the rSTA 106 verifies at least one MPDU, preferably before the tSTA 102 finishes transmitting to the rSTA 106. An MPDU may be verified when the MPDU does not have errors, for example by determining the FCS value of the MPDU is valid.

The third signal process 400 may begin with the tSTA 102 sending an AMPDU 406 to the rSTA 106 via the first rSTA link 402. The AMPDU 406 may be part of one or more PPDUs the tSTA 102 is transmitting to the rSTA 106. As the rSTA 106 receives the AMPDU 406, the rSTA 106 may evaluate the MPDUs of AMPDU 406 to verify the MPDUs that are intended for the dSTA 104 and/or the MPDU does not have errors (e.g., using the FCS values of the MPDU). In one embodiment, the rSTA 106 may identify the first (e.g., as received in the order from the tSTA 102) verified MPDU of the AMPDU 406 and transmit the first verified MPDU and every MPDU after the first verified MPDU to the dSTA 104. The rSTA 106 may transmit the MPDUs via the second rSTA link 404, sending the forwarded MPDUs 408 to the dSTA 104. The rSTA 106 may transmit the forwarded PPDUs while the tSTA 102 is transmitting the AMPDU 406.

In a second embodiment, the data rate of the second rSTA link 404 with the dSTA 104 may be the same or higher than the data rate of the first rSTA link 402 with the tSTA 102. Because stopping a PPDU partway through or padding a PPDU to wait to receive more MPDUs from AMPDU 406 transmission offers little benefit, the rSTA 106 may transmit multiple PPDUs during the transmission of the forwarded MPDUs 408. The rSTA 106 may populate the PPDUs only with verified MPDUs. In an example implementation, the rSTA 106 may send a PPDU of verified MPDUs every time the rSTA 106 has received a predefined amount of verified MPDUs (e.g., four MPDUs, eight MPDUs, sixteen MPDUs, etc.) or a predefined period of verified MPDUs (e.g., one milliseconds, two milliseconds, three milliseconds, etc.). The rSTA 106 may send a final PPDU with the remaining verified MPDUs when the transmission of AMPDU 406 is complete. If enough MPDUs are evaluated as bad, the duration of the forwarded MPDUs 408 may be less than the TXOP duration received from the tSTA 102. Thus, the rSTA 106 may cancel any remaining Network Allocation Vector (NAV) protection to free up the medium. If all or a majority of MPDUs are verified, the technique of the second embodiment may cause the transmission of the forwarded MPDUs 408 to take longer than the AMPDU 406 transmission due to extra preambles and or SIFS between PPDUs, and the tSTA 102 should control this behavior and account for this behavior in its NAV calculation, for example since the end-to-end ACK 214 could arrive later.

In a third embodiment, the data rate of the second rSTA link 404 with the dSTA 104 may be lower than the data rate of the first rSTA link 402 with the tSTA 102. The rSTA 106 may transmit a single lower-rate PPDU in the third embodiment, and the rSTA 106 may populate the lower-rate PPDU only with verified MPDUs. If there is an MPDU error rate high enough that the rSTA 106 has to wait for further MPDUs during the AMPDU 406 transmission, the rSTA 106 may insert padding between verified MPDUs. However, the verified MPDUs of the AMPDU 406 may typically arrive at the rSTA 106 quicker than the rSTA 106 can transmit the verified MPDUs to the dSTA 104 via the forwarded MPDUs 408. In an example implementation, the rSTA 106 may provide for a known PPDU length by transmitting two PPDUs: one PPDU ending at or near the end of the AMPDU 406 transmission and a second PPDU for the remainder of the MPDUs the rSTA 106 needs to send after the AMPDU 406 transmission.

In example implementations, the rSTA 106, or tSTA 102 that provides control to the rSTA 106, can use heuristics (e.g., recent MPDU error rate) to dynamically determine which of the first embodiment, the second embodiment, and the third embodiment is more likely to be more efficient to determine which technique to use. Once the rSTA 106 transmits the forwarded MPDUs 408 to the dSTA 104, the dSTA 104 may send a dSTA ACK signal 212 to the rSTA 106 via the second rSTA link 404. The rSTA 106 may then transmit the end-to-end ACK signal 214 to the tSTA 102 using the first rSTA link 402.

The third signal process 400 may be a part of or otherwise incorporated into the first signal process 200 in some embodiments. For example, the AMPDU 406 transmission may be the first hop frame 204 and the forwarded MPDUs 408 may be second hop frame 210. Accordingly, the relay between the tSTA 102, the dSTA 104, and the rSTA 106 may be improved by implementing the end-to-end ACK signal 214, the tSTA 102 determining the TXOP duration, enabling the rSTA 106 to relay TSF timing information to the dSTA 104, and/or enabling the rSTA 106 to receive a transmission from the tSTA 102 and relay the transmission to the dSTA 104 simultaneously.

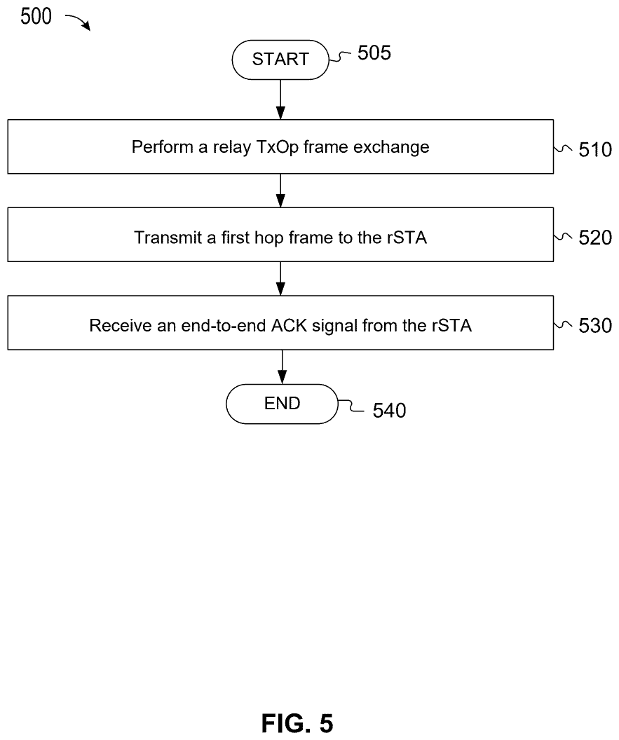

FIG. 5 is a flow chart of a method 500 for improving relay operation in wireless networks. The method 500 may begin at starting block 505 and proceed to operation 510. In operation 510, a relay TXOP frame exchange may be performed with a rSTA. For example, the tSTA 102 may perform the relay TXOP frame exchange 202 with the rSTA 106, and the relay TXOP frame exchange 202 comprises setting a MCS for the second hop frame 210. The relay TXOP frame exchange 202 may also include the dSTA 104 in some embodiments. The tSTA 102 may set a duration for the TXOP of the transmission to the dSTA 104, including the first hop frame 204 and the second hop frame 210. The duration of the TXOP may be based on the MCS the tSTA 102 sets for the second hop frame 210.

In operation 520, a first hop frame is transmitted to the rSTA. For example, the tSTA 102 may transmit the first hop frame 204 to the rSTA 106. The rSTA 106 may transmit the first hop frame 204 or the information included in the first hop frame 204 to the dSTA 104 via the second hop frame 210. The dSTA 104 may send the dSTA ACK signal 212 when the dSTA 104 receives the second hop frame 210.

In operation 530, an end-to-end ACK signal is received from the rSTA. For example, the tSTA 102 receives the end-to-end ACK signal 214 from the rSTA 106. The end-to-end ACK signal 214 can include hop bits that indicate whether the first hop frame and the second hop frame are successfully transmitted, one or more RTS and CTS process bits that indicate whether the rSTA 106 transmitting the RTS signal 206 to the dSTA 104 and the dSTA 104 transmitting the CTS signal 208 to the rSTA 106 was successful, MPDU bits for one or more MPDUs to indicate whether the one or more MPDUs are successfully transmitted (e.g., indicating that verified MPDUs were sent and MPDUs evaluated to be bad were not sent to the dSTA 104, information associated with a connection between the rSTA 106 and the dSTA 104, and/or the like.

The tSTA 102 can also transmit the TSF beacon 302 to the rSTA 106 so the rSTA 106 can send the forwarded TSF beacon 304. The rSTA 106 or the dSTA 104 can modify the TSF timing information for the dSTA 104 to use as described above with respect to FIG. 3. In some embodiments, the first hop frame 204 can include an AMPDU 406 comprising a plurality of MPDUs, and the rSTA 106 may be operable evaluate the plurality of MPDUs of the AMPDU 406 to verify at least a portion of the plurality of MPDUs of the AMPDU 406. The rSTA 106 may transmit the forwarded MPDUs 408 to the dSTA 104 according to the methods described above, including (i) identifying a first verified MPDU of the plurality of MPDUs and transmitting the first verified MPDU and each MPDU of the plurality of MPDUs after the first verified MPDU (e.g., received after the first verified MPDU or otherwise later in the sequence of the plurality of MPDUs) to the dSTA 104, (ii) transmitting a plurality of PPDUs to the dSTA 104, each PPDU comprising one or more verified MPDUs, or (iii) transmitting a single PPDU comprising each verified MPDU to the dSTA 104. The method 500 may conclude at ending block 540.

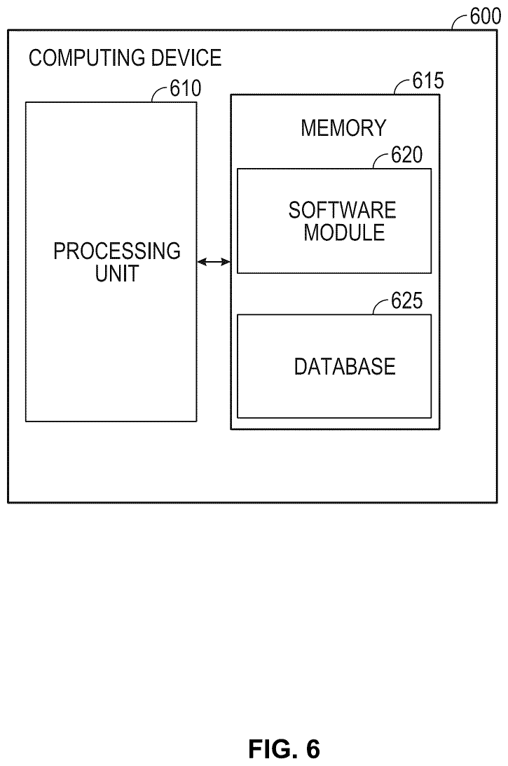

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for improving relay operation in wireless networks with respect to FIG. 1, FIG. 2, FIG. 3, FIG. 4, and FIG. 5. Computing device 600, for example, may provide an operating environment for the tSTA 102, the dSTA 104, the rSTA 106, and the like. The STA 102, the dSTA 104, the rSTA 106, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
performing a relay Transmit Opportunity (TXOP) frame exchange with a Relay Station (rSTA), wherein the TXOP frame exchange comprises setting a Modulation and Coding Scheme (MCS) for a second hop frame the rSTA will transmit to a Destination STA (dSTA);
transmitting a first hop frame to the rSTA for the rSTA to transmit to the dSTA via the second hop frame; and
receiving an end-to-end Acknowledge (ACK) signal from the rSTA.

2. The method of claim 1, further comprising setting a duration of a TXOP for transmitting the first hop frame and the transmitting of the second hop frame, wherein setting the duration is based on the MCS for the second hop frame.

3. The method of claim 1, wherein the end-to-end ACK signal comprises any one of: (i) hop bits that indicate whether the first hop frame and the second hop frame are successfully transmitted, (ii) one or more Request to Send (RTS) and Clear to Send (CTS) process bits that indicate whether a RTS and CTS process was successful, (iii) Media Access Control Protocol Data Unit (MPDU) bits for one or more MPDUs to indicate whether the one or more MPDUs are successfully transmitted, (iv) information associated with a connection between the rSTA and the dSTA, or (v) any combination of (i)-(iv).

4. The method of claim 1, further comprising:
transmitting Timing Synchronization Function (TSF) beacon comprising TSF traffic information to the rSTA, wherein:
the rSTA is operable to perform any one of (i) changing a frame subtype of the TSF beacon to an echoed beacon type, (ii) overwriting a Transmitter Address (TA) of the TSF beacon with a Media Access Control (MAC) address of the rSTA, (iii) generating an encapsulated relayed management frame containing the TSF traffic information, or (iv) any combination of (i)-(iii); and
the rSTA is operable to modify the TSF traffic information to account for a delay between the rSTA receiving the TSF beacon and the rSTA transmitting the TSF traffic information to the dSTA.

5. The method of claim 1, further comprising:
transmitting a Timing Synchronization Function (TSF) beacon comprising TSF traffic information to the rSTA, wherein:
the rSTA is operable to perform any one of (i) changing a frame subtype of the TSF beacon to an echoed beacon type, (ii) overwriting a Transmitter Address (TA) of the TSF beacon with a Media Access Control (MAC) address of the rSTA, (iii) generating an encapsulated relayed management frame containing the TSF traffic information, or (iv) any combination of (i)-(iii); and
the dSTA is operable to modify the TSF traffic information to account for a delay between the rSTA receiving the TSF beacon and the rSTA transmitting the TSF traffic information to the dSTA.

6. The method of claim 1, wherein:
the first hop frame comprises an Aggregate MPDU (AMPDU) comprising a plurality of MPDUs; and
the rSTA is operable to evaluate the plurality of MPDUs of the AMPDU to verify at least a portion of the plurality of MPDUs of the AMPDU.

7. The method of claim 6, wherein the rSTA is operable to perform any one of: (i) identify a first verified MPDU from the plurality of MPDUs and transmit the first verified MPDU and each MPDU of the plurality of MPDUs that are after the first verified MPDU to the dSTA, (ii) transmit a plurality of Physical Layer Protocol Data Units (PPDUs) to the dSTA, each PPDU comprising one or more verified MPDUs of the plurality of MPDUs, or (iii) transmit a single PPDU comprising each verified MPDU of the plurality of MPDUs.

8. A system comprising:
a memory storage; and
a processing unit coupled to the memory storage, wherein the processing unit is operative to:
perform a relay Transmit Opportunity (TXOP) frame exchange with a Relay Station (rSTA), wherein the TXOP frame exchange comprises to set a Modulation and Coding Scheme (MCS) for a second hop frame the rSTA will transmit to a Destination STA (dSTA);
transmit a first hop frame to the rSTA for the rSTA to transmit to the dSTA via the second hop frame; and
receive an end-to-end Acknowledge (ACK) signal from the rSTA.

9. The system of claim 8, the processing unit being further operative to set a duration of a TXOP to transmit the first hop frame and the rSTA to transmit the second hop frame, wherein to set the duration is based on the MCS for the second hop frame.

10. The system of claim 8, wherein the end-to-end ACK signal comprises any one of: (i) hop bits that indicate whether the first hop frame and the second hop frame are successfully transmitted, (ii) one or more Request to Send (RTS) and Clear to Send (CTS) process bits that indicate whether a RTS and CTS process was successful, (iii) Media Access Control Protocol Data Unit (MPDU) bits for one or more MPDUs to indicate whether the one or more MPDUs are successfully transmitted, (iv) information associated with a connection between the rSTA and the dSTA, or (v) any combination of (i)-(iv).

11. The system of claim 8, the processing unit being further operative to:
transmit Timing Synchronization Function (TSF) beacon comprising TSF traffic information to the rSTA, wherein:
the rSTA is operable to perform any one of (i) change a frame subtype of the TSF beacon to an echoed beacon type, (ii) overwrite a Transmitter Address (TA) of the TSF beacon with a Media Access Control (MAC) address of the rSTA, (iii) generate an encapsulated relayed management frame containing the TSF traffic information, or (iv) any combination of (i)-(iii); and
the rSTA is operable to modify the TSF traffic information to account for a delay between the rSTA receiving the TSF beacon and the rSTA transmitting the TSF traffic information to the dSTA.

12. The system of claim 8, the processing unit being further operative to:
transmit a Timing Synchronization Function (TSF) beacon comprising TSF traffic information to the rSTA, wherein:
the rSTA is operable to perform any one of (i) change a frame subtype of the TSF beacon to an echoed beacon type, (ii) overwrite a Transmitter Address (TA) of the TSF beacon with a Media Access Control (MAC) address of the rSTA, (iii) generate an encapsulated relayed management frame containing the TSF traffic information, or (iv) any combination of (i)-(iii); and
the dSTA is operable to modify the TSF traffic information to account for a delay between the rSTA receiving the TSF beacon and the rSTA transmitting the TSF traffic information to the dSTA.

13. The system of claim 8, wherein:
the first hop frame comprises an Aggregate MPDU (AMPDU) comprising a plurality of MPDUs; and
the rSTA is operable to evaluate the plurality of MPDUs of the AMPDU to verify at least a portion of the plurality of MPDUs of the AMPDU.

14. The system of claim 13, wherein the rSTA is operable to perform any one of: (i) identify a first verified MPDU from the plurality of MPDUs and transmit the first verified MPDU and each MPDU of the plurality of MPDUs that are after the first verified MPDU to the dSTA, (ii) transmit a plurality of Physical Layer Protocol Data Units (PPDUs) to the dSTA, each PPDU comprising one or more verified MPDUs of the plurality of MPDUs, or (iii) transmit a single PPDU comprising each verified MPDU of the plurality of MPDUs.

15. A non-transitory computer-readable medium that stores a set of instructions which when executed perform a method executed by the set of instructions comprising:
performing a relay Transmit Opportunity (TXOP) frame exchange with a Relay Station (rSTA), wherein the TXOP frame exchange comprises setting a Modulation and Coding Scheme (MCS) for a second hop frame the rSTA will transmit to a Destination STA (dSTA);
transmitting a first hop frame to the rSTA for the rSTA to transmit to the dSTA via the second hop frame; and
receiving an end-to-end Acknowledge (ACK) signal from the rSTA.

16. The non-transitory computer-readable medium of claim 15, the method executed by the set of instructions further comprising:
setting a duration of a TXOP for transmitting the first hop frame and the transmitting of the second hop frame, wherein setting the duration is based on the MCS for the second hop frame.

17. The non-transitory computer-readable medium of claim 15, wherein the end-to-end ACK signal comprises any one of: (i) hop bits that indicate whether the first hop frame and the second hop frame are successfully transmitted, (ii) one or more Request to Send (RTS) and Clear to Send (CTS) process bits that indicate whether a RTS and CTS process was successful, (iii) Media Access Control Protocol Data Unit (MPDU) bits for one or more MPDUs to indicate whether the one or more MPDUs are successfully transmitted, (iv) information associated with a connection between the rSTA and the dSTA, or (v) any combination of (i)-(iv).

18. The non-transitory computer-readable medium of claim 15, the method executed by the set of instructions further comprising:
transmitting Timing Synchronization Function (TSF) beacon comprising TSF traffic information to the rSTA, wherein:
the rSTA is operable to perform any one of (i) changing a frame subtype of the TSF beacon to an echoed beacon type, (ii) overwriting a Transmitter Address (TA) of the TSF beacon with a Media Access Control (MAC) address of the rSTA, (iii) generating an encapsulated relayed management frame containing the TSF traffic information, or (iv) any combination of (i)-(iii); and
the rSTA is operable to modify the TSF traffic information to account for a delay between the rSTA receiving the TSF beacon and the rSTA transmitting the TSF traffic information to the dSTA.

19. The non-transitory computer-readable medium of claim 15, the method executed by the set of instructions further comprising:
transmitting a Timing Synchronization Function (TSF) beacon comprising TSF traffic information to the rSTA, wherein:
the rSTA is operable to perform any one of (i) changing a frame subtype of the TSF beacon to an echoed beacon type, (ii) overwriting a Transmitter Address (TA) of the TSF beacon with a Media Access Control (MAC) address of the rSTA, (iii) generating an encapsulated relayed management frame containing the TSF traffic information, or (iv) any combination of (i)-(iii); and
the dSTA is operable to modify the TSF traffic information to account for a delay between the rSTA receiving the TSF beacon and the rSTA transmitting the TSF traffic information to the dSTA.

20. The non-transitory computer-readable medium of claim 15, wherein:
the first hop frame comprises an Aggregate MPDU (AMPDU) comprising a plurality of MPDUs; and
the rSTA is operable to evaluate the plurality of MPDUs of the AMPDU to verify at least a portion of the plurality of MPDUs of the AMPDU.
